(19) United States
(12) Patent Application Publication
(10) Pub. No.: US 2026/0316235 A1
(43) Pub. Date: Oct. 15, 2026

(54) INCLINE PLANE TORQUE LIMITING HARDWARE

(71) Applicant: Hubbell Incorporated, Shelton, CT (US)

(72) Inventor: Pieter Jere Beckman, Nottingham, NH (US)

(21) Appl. No.: 19/345,394

(22) Filed: Sep. 30, 2025

Related U.S. Application Data
(60) Provisional application No. 63/700,978, filed on Sep. 30, 2024.

(51) Int. Cl. B25B 23/14; B25B 23/142

(52) U.S. Cl. CPC B25B 23/141; B25B 23/1427

(57) ABSTRACT

A torque limiting apparatus for a rotational mechanical fastener includes a driver head configured with a spring recess, a planar wave-spring positioned within the spring recess, a torque drive section with female ramps and a floating incline plane element configured with male ramps that match the female ramps. The planar wave-spring has ridges extending upward in a longitudinal direction which are positioned in contact with the floating incline plane element. As the torque limiting apparatus is tightened the planar wave-spring becomes compressed, and the male ramps begin to slip upward on the female ramps. Upon reaching a torque limit threshold force the male and female ramps become unmated, allowing the rotational mechanical fastener to rotate freely.

### CROSS-REFERENCE TO RELATED APPLICATION

This application claims the benefit of U.S. Provisional Application No. 63/700,978, filed Sep. 30, 2024, the entire contents of which is incorporated herein by reference in its entirety.

### FIELD

The present disclosure relates to torque limiting hardware to limit the amount of rotational force used in tightening a threaded mechanical fastener. More particularly, the present disclosure relates to incline-plane torque limiting hardware for use in tightening a threaded mechanical fastener.

### BACKGROUND

Fastener torque is the amount of rotational force applied to a fastener during tightening. Proper fastener torque ensures structural integrity and functionality of the fastener. Applying the correct amount of fastener torque to the fastener to tighten it is important to prevent over-tightening or under-tightening. Over-tightening can cause damage to either the item the fastener is being tightened to, or to the fastener itself. Under tightening can result in loose connections, premature failure, or damage to the threads of the fastener.

The use of proper fastener torque is important in several respects. It helps to improve performance of the fastener, increases longevity of the fastener and the item to which it is fastened, and improves safety by eliminating loose connections. Use of the proper fastener torque also aids in reducing stress and wear on the fastener and increases the service life of the fastener and the item(s) to which it is attached.

Some conventional torque limiting fasteners use a breakaway method in which the head of the fastener breaks off within a predesigned torque value range. In other words, the break-off torque is the rotating force required to break the head off. However, the actual break-off torque values of such breakoff hardware can vary considerably due to variations in material quality, manufacturing processes, temperature (e.g., especially in plastics), or other environmental factors.

### SUMMARY

Various embodiments of the present disclosure can overcome the afore-mentioned disadvantages and other drawbacks associated with conventional torque limiting fasteners and offer new advantages as well. For example, through use of various embodiments the functionality of the torque limiting hardware can be tested without testing to failure as is required with conventional break-off hardware. Another advantage of various embodiments disclosed herein is that the torque limit can be altered by switching out the planar wave-spring—e.g., using a planar wave-spring constructed from an alternate material or having a different thickness or different dimensions.

The torque limiting hardware according to various embodiments can embodied with several different faster head/drive types—e.g., eye, hex, socket, or the like. Some embodiments can be implemented a part of the threaded base (i.e., part of the fastener itself) or can be used as a torque limiting attachment that is removed upon tightening the fastener using the proper amount of fastener torque. Further, various embodiments eliminate the litter and waste produced by conventional metal and plastic non-captive break-off hardware.

According to various embodiments of the present disclosure there is provided a torque limiting apparatus for a rotational mechanical fastener that includes a driver head bisected by a longitudinal axis, a torque drive section configured as part of the driver head and configured to rotate about the longitudinal axis, a spring recess concentric to the longitudinal axis formed within the driver head that includes an inner proximal driver-head surface, a number of male driver elements protruding in a radial direction perpendicular to the longitudinal axis, a floating incline plane element positioned to be bisected by the longitudinal axis, a shank component with male threads and configured to have a proximal shank-end, wherein the proximal shank-end is positioned to extend into the spring recess, a planar wave-spring element with a rotational center point and a number of ridges extending in a longitudinal direction, wherein the wave-spring element is positioned within the spring recess around the shank component, one or more male ramps, and one or more female ramps shaped to match the one or more male ramps. Applying rotational force to the driver head with the one or more male ramps mated with the one or more female ramps causes longitudinal force to be applied between the one or more male ramps and the one or more female ramps resulting in compression force being applied to the planar wave-spring element.

In some forms of the planar wave-spring torque limiting fastener the male ramps are configured as part of the floating incline plane element, and female ramps are configured as part of the shank component.

In some forms, the planar wave-spring torque limiting fastener includes a number of female driver elements hollowed out in a radial direction perpendicular to the longitudinal axis and shaped to match the at least one male driver element.

In some forms of the planar wave-spring torque limiting fastener the male driver elements protrude from the inner surface of the driver head in a radial direction towards the longitudinal axis, and the female driver elements are hollowed out of the floating incline plane element.

Some forms of the planar wave-spring torque limiting fastener include a retaining clip removably attached to the driver head and configured to keep the shank component pressed into the spring recess of the driver head.

In some forms of the planar wave-spring torque limiting fastener the rotational force applied to the driver head is a first rotational force, and the compression force applied to the planar wave-spring element is a first compression force. Applying a second rotational force to the driver head results in a second compression force being applied to the planar wave-spring element, the second rotational force being greater than the first rotational force, and the second compression force being greater than the first compression force.

In some forms of the planar wave-spring torque limiting fastener applying a torque limit threshold force to the driver head causes the plurality of male ramps to become unmated from the plurality of female ramps.

In some forms of the planar wave-spring torque limiting fastener the torque limit threshold force is a maximum force the torque limiting apparatus allows to be applied to the rotational mechanical fastener.

In some forms, there is a torque limiting apparatus for a rotational mechanical fastener that includes a driver head with a spring recess, a shank component that extends at least partially into the spring recess, a floating incline plane element, and a a planar wave-spring element with a rotational center point and a number of ridges extending in a longitudinal direction. The shank component includes a fixed ramp section having a female ramp. The floating incline plane element is coupled to the shank element proximate to the fixed ramp section and has a male ramp. The wave-spring element is positioned within the spring recess around the shank component. Applying rotational force to the driver head with the male ramp mated with the female ramp causes longitudinal force to be applied between the one or more male ramps and the one or more female ramps resulting in compression force being applied to the planar wave-spring element.

In some forms, there is a method of tightening a torque limiting apparatus for a rotational mechanical fastener. A tool head can be positioned onto a driver head. A first rotational force is applied to the driver head via the tool to rotate a shank coupled to the driver head. The shank includes a fixed ramp section having a female ramp. A male ramp of a floating ramp element is caused to engage the female ramp. The fixed ramp section is driven into a cavity of the driver head and compressing a wave spring. A torque limit threshold is reached and the male ramp is caused to disengage from the female ramp so that the floating ramp element slides relative to the fixed ramp section and the first rotational force is no longer transferred to the shank.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1A is an exploded side view of incline-plane torque limiting hardware for a threaded mechanical fastener according to various embodiments disclosed herein.

FIG. 1B is an exploded perspective view of incline-plane torque limiting hardware for a threaded mechanical fastener according to various embodiments disclosed herein.

FIG. 2 is an exploded side view of incline-plane torque limiting hardware for a threaded mechanical fastener according to various embodiments disclosed herein.

FIG. 3 is a cross-sectional top view of an incline-plane torque limiting hardware for a threaded mechanical fastener according to various embodiments disclosed herein.

FIG. 4 is a perspective view of a planar wave-spring according to various embodiments disclosed herein.

FIG. 5 is a perspective view of the incline-plane torque limiting hardware rotated in a clockwise direction.

FIG. 6 is a perspective view of the incline-plane torque limiting hardware rotated in a counterclockwise direction.

### DETAILED DESCRIPTIONS

The figures depict a presently preferred embodiment of incline-plane torque limiting hardware for a threaded mechanical fastener. As depicted, the various embodiments are configured for use as incline-plane torque limiting hardware that ensures the proper amount of rotational force is used to tighten a threaded fastener.

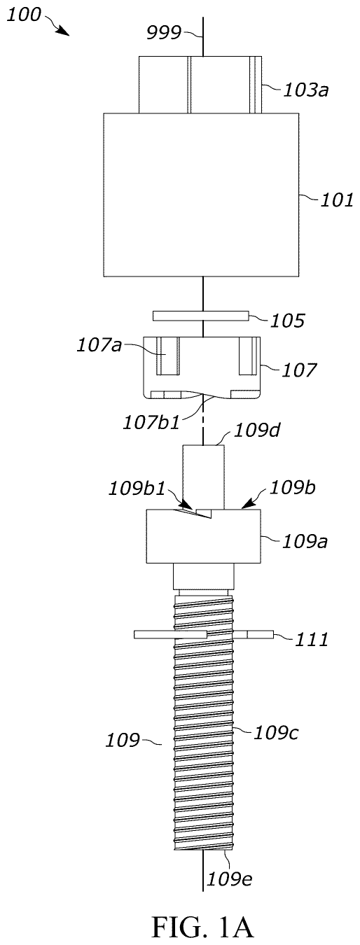

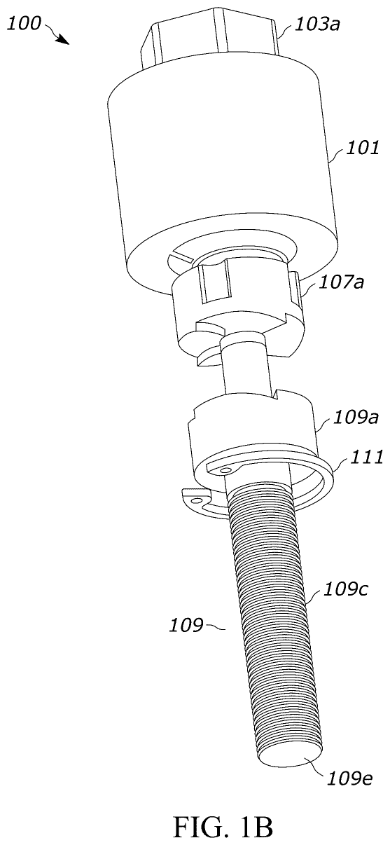

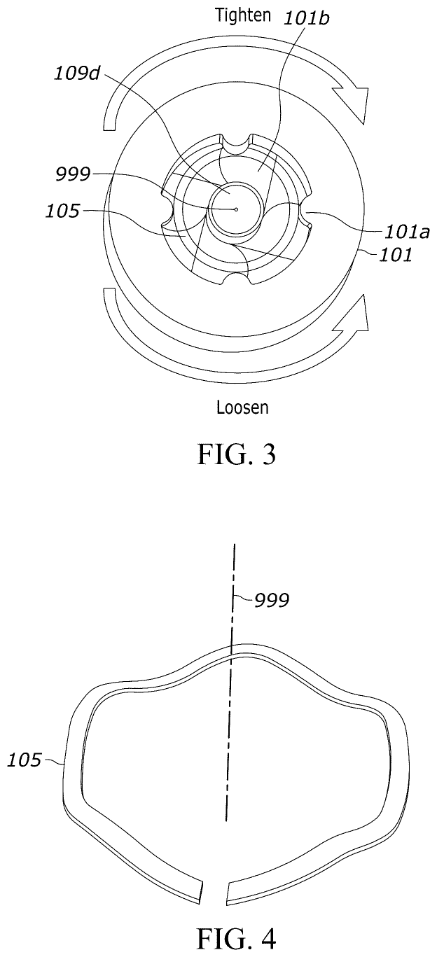

FIG. 1A is an exploded side view of incline-plane torque limiting hardware for a threaded mechanical fastener 100 according to various embodiments disclosed herein. FIG. 1B is an exploded perspective view of incline-plane torque limiting hardware for a threaded mechanical fastener 100 according to various embodiments disclosed herein. The incline-plane torque limiting hardware includes a driver head 101, a torque driver section 103a, a planar wave-spring 105, a floating incline plane component 107 and a shank component 109. The shank component 109 has male threads that fit within a hole with female threads. The threads may be akin to bolt threads designed to fit into a female threaded hole, or may be similar to screw threads configured to be screwed into a solid material such as wood or sheet metal. The floating incline plane component 107 is configured with one or more female driver elements 107a, each of which is shaped to accept a male driver element 101a protruding in a radial direction from the inner surface of driver head 101. The male driver elements 101a are shown in FIG. 3.

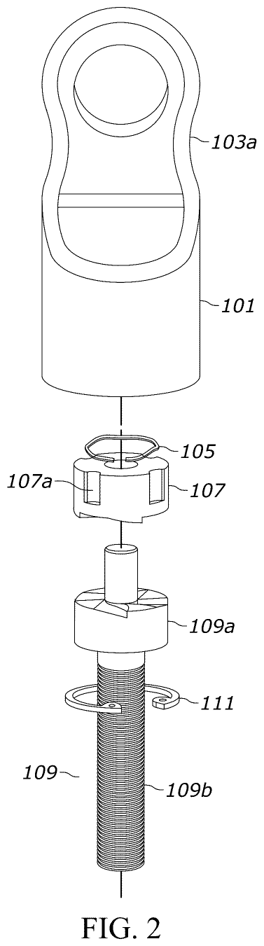

The driver head 101 is configured with a torque drive section 103a. Typically, the torque drive section 103a is shaped to allow insertion and removal of a tool that provides leverage for tightening and loosening the incline-plane torque limiting hardware. The torque drive section 103a depicted in FIGS. 1A-B is hex shaped, and may be sized to be driven by a type of mechanic's wrench—e.g., a combination wrench, box end wrench, socket wrench, etc.—or may be driven by an adjustable wrench such as pliers, an adjustable groove joint wrench, adjustable spanner wrench (e.g., Crescent™ wrench) or the like. The torque drive section 103a may be configured to use other types of wrenches or drivers such as a square driver, a torx driver, a slotted or Phillips head screw driver, a spanner screwdriver, or other like types of rotational drivers known to those of ordinary skill in the art. The torque drive section 103a of FIG. 2 has an insertion hole that can be driven by inserting a rod or screw driver, or may be rotated by hand or with a pair of pliers, etc. The torque drive section 103a rotates about the longitudinal axis of threaded mechanical fastener 100 which is depicted as centerline 999.

The shank component 109 is typically configured with a spring ramp section 109a and a threaded section 109c. The spring ramp section 109a extends upward from the threaded section 109c towards a proximal end 109d of shank component 109. The spring ramp section 109a is configured with one or more female ramps 109b1 that are shaped to match a male ramp 107b1 on the floating incline plane component 107. Various embodiments may have one, two, three, four or more female ramps 109b1. The floating incline plane component 107 may have the same number, or fewer, of male ramps 107b1 as the number of female ramps 109b1, but cannot have more. In some embodiments the spring ramp section 109a may be configured with male ramps shaped to match female ramps on the floating incline plane component 107. Male ramps protrude outward from a component, while female ramps are hollowed out within a component.

FIG. 4 depicts a planar wave spring 105 according to various embodiments disclosed herein. The planar wave-spring 105—sometimes called a planar wave-spring element 105—fits within the driver head 101, above the floating incline plane component 107. The planar wave spring 105 has a number of ridges (and valleys) extending in a longitudinal direction. The ridges of the planar wave spring 105 flatten out in response to compression force being applied in the longitudinal direction, that is, in a direction parallel to centerline 999. Typically, the compression force is a longitudinal force-that is, force applied in the longitudinal direction. If the compression force is removed the ridges spring back upward, allowing the planar wave spring 105 to return to its original shape.

FIG. 2 is an exploded side view of incline-plane torque limiting hardware for a threaded mechanical fastener 100 according to various embodiments disclosed herein. The planar wave-spring 105 can be seen positioned above the floating incline plane component 107. The proximal end 109d of shank component 109 extends through floating incline plane component 107 and the planar wave-spring 105, and into a recessed portion of driver head 101 to keep the planar wave-spring 105 in place within driver head 101. The recessed portion of driver head 101 may be called a spring recess since the planar wave-spring 105 is positioned within it. The lateral surface of the recess in driver head 101 is called an inner proximal driver-head surface.

FIG. 3 is a cross-sectional top view of incline-plane torque limiting hardware for a threaded mechanical fastener 100 according to various embodiments disclosed herein. The inner surface of driver head 101 has one or more male driver element 101a protruding from it in a radial direction towards the centerline 999 which is the longitudinal axis of threaded mechanical fastener 100. The embodiment depicted in FIG. 3 has four male driver element 101a with a round shaped extending inward towards the centerline 999 from the inner proximal driver-head surface inside driver head recess 101b of the driver head 101. Other embodiments may be implemented with two, three or another number of male driver elements 101a. In some implementations the male driver elements 101a may be rectangular in shape, or Vee shaped, or another shape, extending inward inside the driver head 101.

The floating incline plane component 107 is configured with one or more female driver elements 107a, each of which is shaped to accept a male driver element 101a protruding from the driver head 101. The shape of the male driver elements 101a matches the shape of the female driver elements 107a formed in floating incline plane component 107. This allows the floating incline plane component 107 to be inserted within the driver head recess 101b so that the male driver elements 101a of driver head 101 can engage the female driver elements 107a of floating incline plane component 107. In this way the driver head 101 can be rotated to tighten or loosen the threaded mechanical fastener 100.

The driver head 101 is held in place over the shank component 109 by retaining clip 111. In the neutral position—sometimes called the unengaged position—the planar wave-spring 105 has either no force being applied to it, or a small amount of force that compresses it slightly in the direction of centerline 999—e.g., compresses it 20% or less. In the neutral position the male ramp 107b1 of floating incline plane component 107 are positioned within the female ramps 109b1 of the shank component spring ramp section 109a.

Applying clockwise rotational force—i.e., torque—to torque driver section 103a causes male ramp 107b1 of floating incline plane component 107 to engage and push against the female ramps 109b1 of the shank component spring ramp section 109a. The clockwise rotational force results in longitudinal force in the direction of centerline 999 between the floating incline plane component 107 and the shank component spring ramp section 109a. Applying more clockwise rotational force to torque driver section 103a causes male ramps 107b1 of floating incline plane component 107 to work their way up female ramps 109b1. Since driver head 101 is affixed to the shank component 109 by retaining clip 111, this forces the floating incline plane component 107 up into the driver head recess 101b, compressing the planar wave-spring 105.

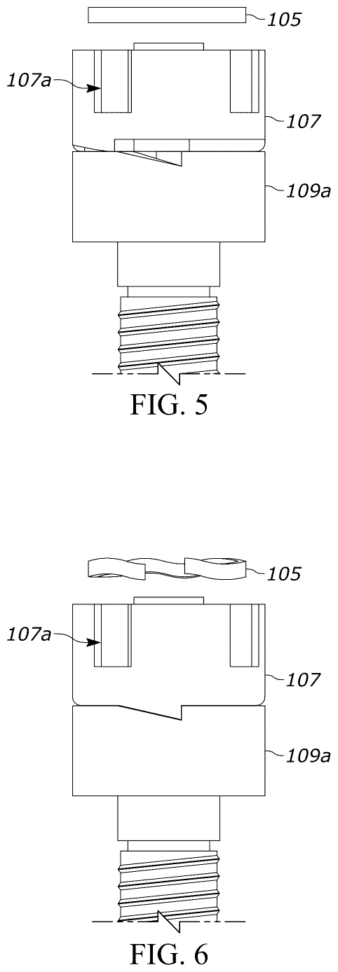

As the clockwise rotational force applied to driver head 101 increases, the longitudinal force between floating incline plane component 107 and shank component spring ramp section 109a also increases. This further compresses the planar wave-spring 105, causing male ramps 107b1 to work their way up female ramps 109b1 so that the male ramps 107b1 are rotationally shifted relative to the female ramps 109b1. As shown in FIG. 5, upon reaching a sufficient amount of clockwise rotational force the planar wave-spring 105 becomes compressed to the point that the male ramps 107b1 reach the top of female ramps 109b1, and become unmated with the female ramps 109b1. That is, the male and female ramps no longer overlap as the male ramps slide up and over, or cam over, the female ramps. This causes the male ramps 107b1 to become unmated with female ramps 109b1 and slide onto the flat incline spring support ledge 109b at the top of shank component ramp section. This allows the driver head 101 to rotate freely without further tightening the threaded mechanical fastener. The clockwise rotational force at which the driver head 101 begins to rotate freely is called the torque limit threshold. The incline-plane torque limiting hardware ensures that the threaded mechanical fastener 100 is tightened no tighter than the torque limit threshold.

The amount of torque is not limited when applying counter-clockwise rotational force to loosen or remove the fastener. As will be appreciated, as the respective ramp faces of the male and female ramp as frictional forced against each other in the counter-clockwise direction (see e.g., FIG. 6), the flat back portions 107b2, 109b2 abut against each other and serve as mechanical stops to prevent movement of the pieces past one another. Thus, all of the rotational force applied to the driver head 101 will be applied to the shank portion of the fastener.

The phrase “torque limiting hardware” used throughout this disclosure of the various embodiments means the same and is interchangeable with the phrase “torque limiting apparatus.” The term “rotational fastener” is used in this disclosure of the various embodiments. A rotational fastener is any type of fastener that tightens and/or loosens in response to the application of rotation force. A bolt (that screws into a nut) is an example of a rotational fastener. A sheet metal screw, a wood screw and a lag bolt are three other examples of rotational fasteners.

The male driver element 101a are described herein as protruding from the inner surface of driver head 101 in a “radial direction” towards the longitudinal axis which is depicted in the figures as centerline 999. The radial direction is perpendicular to, and intersects, the longitudinal axis—i.e., centerline 999. The “longitudinal direction” is parallel to the longitudinal axis. The female driver elements 107a and male driver elements 101a are described herein as being “shaped to match”. A male component “shaped to match” a female component will fit into a recessed or hollowed out portion of the female component. A female component “shaped to match” a male component will accept at least a portion of the male component into a recessed or hollowed out portion.

The phrase “longitudinal force” means force applied in a longitudinal direction. The phrase “compression force” in regard to a spring means force that causes the spring to compress to some extent. Male ramps (e.g., male ramps 107b1) are said to be “mated” to female ramps (e.g., female ramps 109b1) so long as the ramps are in contact with each other. If a male ramp slides up a female ramp and past the edge of the female ramp, the male and female ramps are said to be “unmated”.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A torque limiting apparatus for a rotational mechanical fastener, comprising:
a driver head bisected by a longitudinal axis;
a torque drive section configured as part of the driver head, the torque drive section configured to rotate about the longitudinal axis;
a spring recess concentric to the longitudinal axis formed within the driver head, the recess including an inner proximal driver-head surface;
at least one male driver element protruding in a radial direction perpendicular to the longitudinal axis;
a floating incline plane element positioned to be bisected by the longitudinal axis;
a shank component with male threads and configured to have a proximal shank-end, wherein the proximal shank-end is positioned to extend into the spring recess;
a planar wave-spring element with a rotational center point and a number of ridges extending in a longitudinal direction, wherein the wave-spring element is positioned within the spring recess around the shank component;
one or more male ramps; and
one or more female ramps shaped to match the one or more male ramps;
wherein, applying rotational force to the driver head with the one or more male ramps mated with the one or more female ramps causes longitudinal force to be applied between the one or more male ramps and the one or more female ramps resulting in compression force being applied to the planar wave-spring element.

2. The torque limiting apparatus of claim 1, wherein the one or more male ramps is a plurality of male ramps; and
wherein the one or more female ramps is a plurality of female ramps.

3. The torque limiting apparatus of claim 2, wherein the plurality of male ramps is configured as part of the floating incline plane element; and
wherein the plurality of female ramps is configured as part of the shank component.

4. The torque limiting apparatus of claim 1, further comprising:
at least one female driver element hollowed out in a radial direction perpendicular to the longitudinal axis, the at least one female driver element being shaped to match the at least one male driver element.

5. The torque limiting apparatus of claim 4, wherein said at least one male driver element is a plurality of male driver elements protruding from the inner proximal driver-head surface of the driver head in a radial direction towards the longitudinal axis.

6. The torque limiting apparatus of claim 5, wherein said at least one female driver element is a plurality of female driver elements hollowed out in the floating incline plane element.

7. The torque limiting apparatus of claim 6, wherein said at least one male driver element is a plurality of male driver elements.

8. The torque limiting apparatus of claim 1, further comprising:
a retaining clip removably attached to the driver head and configured to keep the shank component pressed into the spring recess of the driver head.

9. The torque limiting apparatus of claim 1, wherein the rotational force applied to the driver head is a first rotational force, and the compression force applied to the planar wave-spring element is a first compression force; and
wherein applying a second rotational force to the driver head results in a second compression force being applied to the planar wave-spring element, the second rotational force being greater than the first rotational force, and the second compression force being greater than the first compression force.

10. The torque limiting apparatus of claim 3, wherein applying a torque limit threshold force to the driver head causes the plurality of male ramps to become unmated from the plurality of female ramps.

11. The torque limiting apparatus of claim 10, wherein the torque limit threshold force is a maximum force the torque limiting apparatus allows to be applied to the rotational mechanical fastener.

12. A torque limiting apparatus for a rotational mechanical fastener, comprising:
a driver head having a spring recess;
a shank component that extends at least partially into the spring recess, wherein the shank component includes a fixed ramp section having a female ramp;
a floating incline plane element coupled to the shank element proximate to the fixed ramp section, the floating incline plane element having a male ramp;
a planar wave-spring element with a rotational center point and a number of ridges extending in a longitudinal direction, wherein the wave-spring element is positioned within the spring recess around the shank component;
wherein, applying rotational force to the driver head with the male ramp mated with the female ramp causes longitudinal force to be applied between the one or more male ramps and the one or more female ramps resulting in compression force being applied to the planar wave-spring element.

13. The torque limiting apparatus of claim 12, further comprising:
a retaining clip removably attached to the driver head and configured to keep the shank component pressed into the spring recess of the driver head.

14. The torque limiting apparatus of claim 12, wherein the rotational force applied to the driver head is a first rotational force, and the compression force applied to the planar wave-spring element is a first compression force; and
wherein applying a second rotational force to the driver head results in a second compression force being applied to the planar wave-spring element, the second rotational force being greater than the first rotational force, and the second compression force being greater than the first compression force.

15. The torque limiting apparatus of claim 12, wherein applying a torque limit threshold force to the driver head causes the plurality of male ramps to become unmated from the plurality of female ramps.

16. The torque limiting apparatus of claim 15, wherein the torque limit threshold force is a maximum force the torque limiting apparatus allows to be applied to the rotational mechanical fastener.

17. The torque limiting apparatus of claim 12, wherein the floating incline plane element includes a first surface facing the fixed ramp section and a second surface opposite to the first surface, and wherein the planar wave-spring element is positioned adjacent to the second surface.

18. A method of tightening a torque limiting apparatus for a rotational mechanical fastener, comprising:
positioning a tool onto a driver head;
applying a first rotational force to the driver head via the tool to rotate a shank coupled to the driver head, wherein the shank includes a fixed ramp section having a female ramp;
causing a male ramp of a floating ramp element to engage the female ramp;
driving the fixed ramp section into a cavity of the driver head and compressing a wave spring; and
reaching a torque limit threshold and causing the male ramp to disengage from the female ramp so that the floating ramp element slides relative to the fixed ramp section and the first rotational force is no longer transferred to the shank.

19. The method of claim 18, wherein the torque limit threshold force is a maximum force the torque limiting apparatus allows to be applied to the rotational mechanical fastener.

20. The method of claim 18, wherein a retaining clip is removably attached to the driver head and configured to keep the shank component pressed into the spring recess of the driver head.
